(19) United States
(12) Patent Application Publication
(10) Pub. No.: US 2007/0118427 A1
(43) Pub. Date: May 24, 2007

(54) Method and system for screening online purchases

(76) Inventor: Paul V. Storm, Dalworthington Gardens, TX (US)

Correspondence Address: STORM LLP, BANK OF AMERICA PLAZA, 901 MAIN STREET, SUITE 7100, DALLAS, TX, 75202, US

(21) Appl. No.: 11/594,673

(22) Filed: Nov. 8, 2006

Related U.S. Application Data
(60) Provisional application No. 60/739,092, filed on Nov. 21, 2005.

(51) Int. Cl. G06Q 20/00; G06Q 40/00

(52) U.S. Cl. 705/18; 705/44

(57) ABSTRACT

In recent years, there has been an increase in both credit card/debit card fraud and online purchasing. Within the emergence of the electronic commerce marketplace, there does not exist the same protections for merchants as there exists for traditional brick-and-mortar stores. Therefore, to assist in preventing fraud, specifically online fraud, with credit/debit cards, another level of abstraction can be added to the purchase system where purchases can be identified as potentially fraudulent. The identification is through the use of correlating purchased items with account identifiers, where the purchase of certain categories of items can predict potential fraudulent procurement of credit/debit card numbers. Thus, by implementation of a simple system, the incidences of fraud can be reduced, protecting both merchants and consumers.

### CLAIM OF PRIORITY

This application claims priority from U.S. Provisional Patent Application No. 60/739,092 entitled “METHOD AND SYSTEM FOR SCREENING ONLINE PURCHASES” filed on behalf of Paul V. Storm, on Nov. 21, 2005, which is incorporated herein by reference for all purposes.

### TECHNICAL FIELD

The invention relates generally to screening online purchases, and more particularly to assisting online merchants in detecting fraudulent purchases.

### BACKGROUND

Today, credit card fraud and “identity theft” have become relatively commonplace. As a result, credit card companies now have policies in place so as to protect unsuspecting consumers from becoming the victims of fraud or deceit. For example, if a thief uses a stolen credit card to make a purchase, the credit card holder will not be liable for the amount of the fraudulent purchase. Moreover, in cases where the credit card was utilized at brick-and-mortar stores, as opposed to an online store, the store owner will not be liable for the loss either.

Online markets have flourished over the past few years, as well. However, within the domain of the electronic markets, the same protections that exist for brick-and-mortar stores do not exist for online merchants. If a fraudulent purchase is made online, an online merchant will be liable for the loss. This is a significant problem because fraudulent use of credit cards is much simpler online due to the lack of a face-to-face interaction, which exists with the brick-and-mortar stores.

In conjunction with the increased incidents of identity theft and credit card fraud, there has been increased usage of credit cards to make grocery purchases. In fact, credit card machines have become relatively ubiquitous in grocery stores anymore. Companies, such as Catalina Marketing, have amassed large databases related to purchases of individual items for the purposes of targeted marketing. These large databases contain information about the purchasing behavior related to specific account identifiers. In fact, patterns in grocery store purchase habits for individual items can be indicative of whether credit card usage is innocuous or fraudulent. However, an analysis of individual items purchased is not currently used to access whether a requested purchase should be approved.

Accordingly, there is a need for a method and/or system for utilizing data stored in marketing databases related to grocery store purchases to screen online purchases to assist online merchants in preventing fraud.

### SUMMARY

The present invention, accordingly, provides a computer program for screening an online purchase with at least one account identifier. A regularity indicia is generated with computer code for the account identifier based on items purchased. Additionally, at least one good or item is purchased online with computer code by using the credit card number from an online merchant. Moreover, the regularity index is reported to the online merchant by employing computer code.

In another preferred embodiment of the present invention, the computer code for generating the regularity indicia further comprises several more sections of computer code. In particular, a purchasing index is generated with computer code based on the cost of a plurality of grocery item purchases. Also, an expenditure index is generated with computer code based on purchases of alcoholic beverages. The regularity indicia is generated by computer code relative to the purchase index and the expenditure index.

In yet another preferred embodiment of the present invention, the computer code for generating the purchase index further comprises additional sections of computer code. Specifically, the grocery item purchases are categorized into a plurality of price tiers, and at least one purchase percentage relative to each of the plurality of price tiers is calculated. The purchase index is then calculated based on the purchase percentages of each of the plurality of price tiers.

In yet another preferred embodiment of the present invention, the computer code for generating the expenditure index further comprises computer code for calculating an alcohol purchase percentage.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram depicting an electronic commerce system;

FIG. 2 is a flow chart depicting a prior-art grocery store correlation method;

FIG. 3 is a flow chart depicting the method for calculating a regularity index; and

FIG. 4 is a flow chart depicting the method for screening online purchases.

### DETAILED DESCRIPTION

In the following discussion, numerous specific details are set forth to provide a thorough understanding of the present invention. Nevertheless, it will be apparent to those skilled in the art that the present invention may be practiced without such specific details. In other instances, well-known elements have been illustrated in schematic or block diagram form in order not to obscure the present invention in unnecessary detail.

Refer now to the drawings wherein depicted elements are, for the sake of clarity, not necessarily shown to scale and wherein like or similar elements are designated by the same reference numeral through the several views. Additionally, the term “account numbers” hereinafter refers to credit card numbers, debit card numbers, or any other number associated with a financial account capable of fulfilling a purchase by electronic means. The term “communication channel” hereinafter refers to any type of electronic communication medium including, but not limited to, wireless, optical, or any other medium capable of supporting packet transmission.

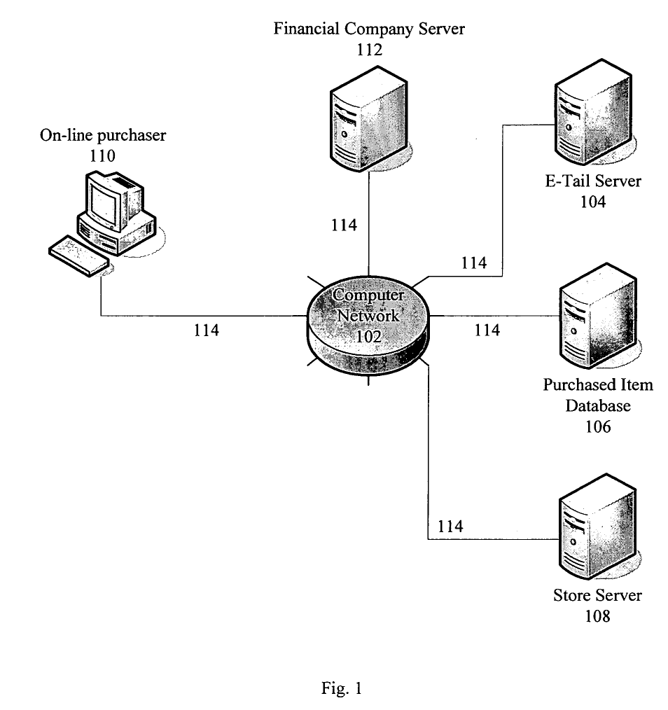

Referring to FIG. 1 of the drawings, the reference numeral 100 generally designates an electronic data commerce system. The system 100 includes a computer network 102, an electronic retail (e-tail) server 104, a purchased item database 106, a store server 108, an online purchaser 110, and a financial company server 112. Each of the e-tail server 104, the purchased item database 106, the store server 108, the online purchaser 110, and the financial company server 112 are connected through a communication channel 114. The combination of the communication channel 114 and the computer network 102, which may be any type of computer network including (but not limited to) the Internet, allow intercommunication between the e-tail server 104, the purchased database 106, the store server 108, the online purchaser 110, and the financial company server 112. In conducting communications over the computer network 102, a variety of protocols can be employed, such as Hypertext Transfer Protocol (HTTP) and HTTP over a Secure Socket Layer (HTTPS). Specifically, this system 100 is flexible enough to be employed with both prior-art methods and/or models as well as systems embodied by the present invention.

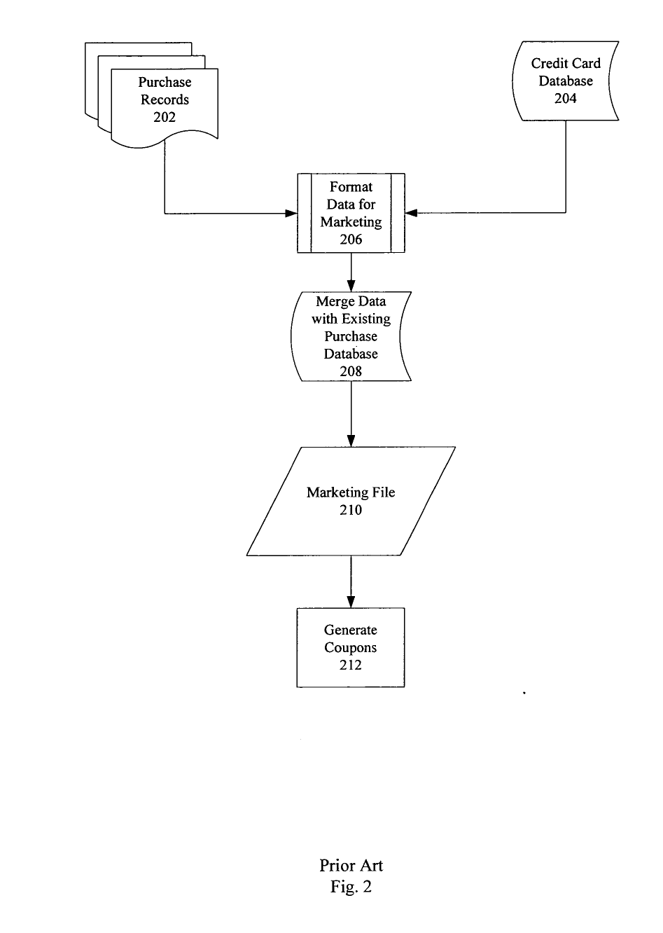

As an example of a prior-art system, FIG. 2 is a flow chart depicting a prior art grocery store correlation method 200 that employs system 100. Specifically, purchase records are generated and/or stored in step 202 at the store server 108. These purchase records 202 detail the items purchased, the cost of each item purchased, the total prices, and an indication of the person who made the purchase. Table 1 below is an example of a purchase record.

TABLE 1

| Item | Cost (in dollars) | Transaction Type | Number |
|---|---|---|---|
| Eggs | 2.52 | Credit Card | 1234-1234-1324- |
| Cheese | 1.85 | | 1234 |
| Bread | 2.25 | | |
| Milk | 3.25 | | |
| TOTAL | 9.87 | | |

Because it has become commonplace to purchase food items and groceries with credit cards, credit/debit card machines have become ubiquitous. As a result, the purchase records can be easily formatted to become marketing records in step 206. However, this can be accomplished by accessing the account number database in step 204, which is controlled by the financial company server 112. Generally, though, the names of the purchasers and account numbers are not known in this database, but instead an account identifier is associated with the specific person or account number so that privacy can be maintained. The formatting in step 206, though, is not typically performed by the grocery store, but instead is performed by the purchased items database 106 at a marketing company.

Once the formatting has been performed, the new purchases are then merged with existing data in step 208. The data related to these purchases is not useless data. Humans are, in fact, very much creatures of habit, and correlations can be drawn between the present/past purchases and future purchases. Hence, other merchants and products manufacturers are able to better market to develop more customized consumer marketing. Therefore, based on this, marketing profiles can be generated in step 210 in order to fulfill this marketing desire so that coupons can be generated in step 212.

Generation of specifically tailored coupons based on previous purchases, though, is well known and has existed for many years. But in that time, a great deal of data has been generated related to the purchasing habits of individuals and, more accurately, purchase habits of specific account identifiers. Based on the purchasing habits related to specific account identifiers, correlations can be drawn as to whether there has been fraudulent procurement and use of account numbers by third parties. In other words, merchants can monitor transactions more carefully so as not to be taken advantage of and so as to better protect consumers.

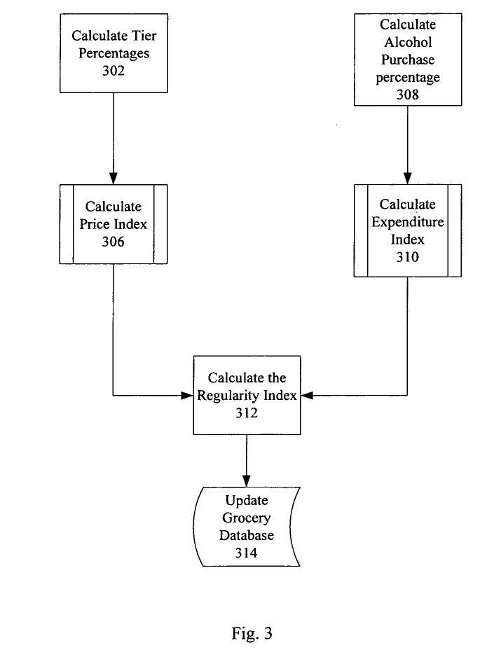

Referring to FIG. 3 of the drawings, the reference numeral 300 generally designates an exemplary flow chart depicting a method for calculating a regularity index for grocery store purchases. A regularity index is a number or other indicator that is generated based on previous grocery store purchases associated with an account identifier, specifically relative costs of grocery store items purchased and the purchase of alcoholic beverages.

Initially, the process of generating a regularity index number or indicia of regularity begins by mining a database of large entries. These entries, for example, could contain an account identifier related to items purchased, costs, time/date, and type of purchase (i.e. cash, credit card, etc.). Table 2 below is an example of a sample of database entries, where multiple entries of a single transaction are linked by an association.

TABLE 2

| Entry | Identifier | Item | Cost | Type | Ass'n | Time | Date |
|---|---|---|---|---|---|---|---|
| 364 | 1234 | Eggs | 2.52 | Debit | | 14:25 CST | Aug. 16, 2005 |
| 365 | 1234 | Cheese | 1.85 | Debit | 364 | 14:25 CST | Aug. 16, 2005 |
| 366 | 1234 | Bread | 2.25 | Debit | 364 | 14:25 CST | Aug. 16, 2005 |
| 367 | 1234 | Milk | 3.25 | Debit | 364 | 14:25 CST | Aug. 16, 2005 |
| 368 | 6543 | Beer | 13.55 | Credit | | 18:33 CST | Aug. 16, 2005 |
| 369 | 6543 | Lobster | 28.30 | Credit | 368 | 18:33 CST | Aug. 16, 2005 |
| 370 | 6543 | Steak | 13.85 | Credit | 368 | 18:33 CST | Aug. 16, 2005 |
| 371 | 7525 | Hamburgers | 12.10 | Credit | | 19:14 CST | Aug. 16, 2005 |
| 372 | 7525 | Bread | 3.25 | Credit | 371 | 19:14 CST | Aug. 16, 2005 |
| 373 | 7525 | Chips | 3.35 | Credit | | 19:27 CST | Aug. 16, 2005 |
| 374 | 7525 | Mustard | 2.35 | Credit | 373 | 19:27 CST | Aug. 16, 2005 |
| 375 | 1234 | Coke | 3.25 | Debit | | 19:33 CST | Aug. 17, 2005 |
| 376 | 1234 | Coke | 3.50 | Debit | 375 | 19:33 CST | Aug. 17, 2005 |
| 377 | 1234 | Beer | 6.25 | Debit | 375 | 19:33 CST | Aug. 17, 2005 |
| 378 | 1234 | Hamburgers | 12.10 | Debit | 375 | 19:33 CST | Aug. 17, 2005 |

The initial step in determining the regularity index number or other indicia of regularity is to choose tiers of items that are categorized by price. There can be any number of tiers; however, three price tiers have been chosen here for the purposes of illustration. Specifically, Price Tier 1 consists of items costing less than five (5) dollars. Price Tier 2 consists of items costing between five (5) and eight (8) dollars, and Price Tier 3 consists of items costing more than 8 dollars. Thus, the criteria for each tier is correlated to the price of an item.

Once chosen, percentages of tiered items can then be calculated for each transaction in step 302. Using the entries from Table 1 above, there are five (5) transactions and three individual account identifiers. The first transaction (for identifier 1234) consists of entries 364, 365, 366, and 367. The second transaction (for identifier 6543) consists of entries 368, 369, and 370. The third transaction (for identifier 7525) consists of entries 371 and 372. The fourth transaction (for identifier 7525) consists of entries 373 and 374. The fifth transaction (for identifier 1234) consists of 375, 376, 377, and 378. Table 3, therefore, illustrates the percentage of tiered products for the three account identifiers.

TABLE 3

| | Price | Price | Price |
|---|---|---|---|
| Identifier | Tier 1 | Tier 2 | Tier 3 |
| 1234 | 75% | 12.5% | 12.5% |
| 6543 | 0 | 0 | 100% |
| 7525 | 80% | 0 | 20% |

In step 306, once the percentages of purchases within a tier have been calculated, another set of tiers is chosen for the price index related to the percentage of Price Tier 3 products. In an example, Price Tier 3 is chosen because there is a correlation between incidences of expensive grocery store item purchases and fraudulent uses. Specifically, in this example, three tiers have been chosen for the price index based on the Price Tier 3 percentages: Low, Medium, and High. Low is chosen to represent percentages between 0% and 25%. Medium is chosen to represent percentages between 25% and 50%, and High is chosen to represent percentages above 50%. Therefore, a direct correlation is drawn between the purchase of high priced grocery items and, as an example, the Price Index is applied in Table 4.

TABLE 4

| Identifier | Price Index |
|---|---|
| 1234 | Low |
| 6543 | High |
| 7525 | Low |

Concurrently with calculating the Price Index, the Expenditure Index is calculated. To determine the Expenditure Index, other percentage calculations are performed. Specifically, in step 308, the Category Expenditures Percentage (CEP) is calculated. In this example, the category chosen is alcoholic beverages. The CEP is the funds expended on alcohol relative total purchases. Alcoholic beverage purchases have also been singled out due to a correlation of alcoholic beverage purchases and fraudulent transactions; however, there are other purchases that can also be associated with fraudulent purchases. As an example, for each of the identifiers in Tables 2 and 3, the percentage category (alcoholic beverages) purchases expenditures are as follows:
CEP₁₂₃₄=$6.25/($34.97)*100%=17.9% (1)
CEP₆₅₄₃=$13.55/($55.70)*100%=24.3% (2)
CEP₇₅₂₅=$0/($21.05)*100%=0% (3)

Additional tiers are then applied to the calculated percentages in step 310 to calculate the Expenditure Index. As an example, three tiers have been chosen: Low, Medium, and High. Low represents percentages less than 10%. Medium represents percentages between 10 and 20%, and High represents percentages above 20%. Therefore, as an example, the price index is applied in Table 5.

TABLE 5

| Identifier | Expenditure Index |
|---|---|
| 1234 | Medium |
| 6543 | High |
| 7525 | Low |

Upon determining both the Expenditure Index and the Price Index, the Regularity Index can be calculated in step 312. The Regularity Index is generated by correlating a number to combinations of the Expenditure Index and the Price Index. As an example, utilizing the three tiers of the Expenditure Index and Price Index detailed above, the Regularity Index scale is shown in Table 6 as follows.

TABLE 6

| Purchase Index | Expenditure Index | Regularity Index |
|---|---|---|
| Low | Low | 1 |
| Low | Medium | 2 |
| Medium | Low | 3 |
| Medium | Medium | 4 |
| Medium | High | 5 |
| High | Medium | 6 |
| High | High | 7 |

As applied to the example above, the Regularity Index for the three identifiers are shown in Table 7 as follows.

TABLE 7

| Identifier | Regularity Index |
|---|---|
| 1234 | 2 |
| 6543 | 7 |
| 7525 | 1 |

The Regularity Index is indicative of the likelihood of fraudulent usage. As shown, a low Regularity Index correlates to a low probability of fraudulent use while a high Regularity Index correlates to a high probability of fraud. Thus, use of this Regularity Index would assist in determining whether online purchases were potentially fraudulent. Therefore, a continually updated Regularity Index can be stored in the grocery store database in step 314. In the case of the example detailed above, identifier 6543 could be flagged as being potentially fraudulent uses because of the high Regularity Index, which indicates a propensity for purchasing expensive grocery store items and alcoholic beverages.

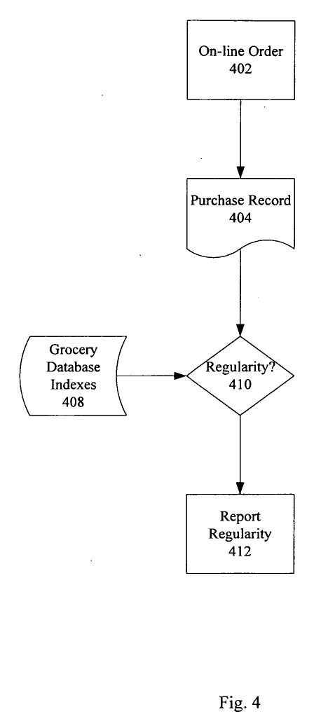

To illustrate an exemplary procedure for flagging potentially fraudulent uses of account identifiers, FIG. 4 depicts a method for screening online purchases. Initially, an online purchaser 110 makes an online purchase in step 402 with an account number so as to generate a purchase record in step 410. As a result of the purchase record, but before any transaction is completed, the e-tail server 104 accesses the purchased items database 106 in step 408. Thus, the Regularity Index associated with the account identifier used for the online purchase is referenced. In response to this reference, a report can be generated in step 412.

The generation of a report can, thus, allow a merchant to perform a check before proceeding with fulfilling the order. The merchant can either contact the online purchaser to verify, contact the credit card company, or contact some other third-party with transaction oversight. The use of the Regularity Index in identifying potentially fraudulent transactions is not a foolproof system; however, an additional layer of security can be added to online transactions, which would reduce the instances of fraud in online transactions.

One advantage of the present invention is that existing data that is almost constantly updated to make these assessments is utilized, and no new gathering of data is required. Another advantage is that the present invention is nominally invasive and requires very little effort and expenditure to implement relative to the potential cost savings.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. A computer program for screening at least one purchase with at least one account number having a medium with a computer program embodied thereon, the computer program comprising:
computer code for generating a regularity indicia for said at least one account identifier based on an analysis of purchased items with said at least one account identifier;
computer code to receive a request for said regularity indicia; and
computer code for reporting said regularity indicia to said online merchant.

2. The computer program of claim 1, wherein said computer code for generating said regularity indicia further comprises:
computer code for generating a purchasing index based on the cost of each of a plurality of purchased items;
computer code for generating a category expenditure index based on purchases of at least one specific category of goods; and
computer code for producing said regularity indicia relative to said purchase index and said category expenditure index.

3. The computer program of claim 2, wherein said computer code for generating a category expenditure index further comprises computer code for generating an alcohol expenditure index based on purchases of alcoholic beverages.

4. The computer program of claim 2, wherein said computer code for generating a category expenditure index further comprises computer code for generating a grocery expenditure index based on purchases of consumable groceries.

5. The computer program of claim 2, wherein said computer code for generating said purchase index number further comprises:
computer code for categorizing said grocery item purchases into a plurality of price tiers;
computer code for calculating at least one purchase percentage relative to each of said plurality of price tiers; and
computer code for calculating a purchase index based one said at least one purchase percentage of each of said plurality of price tiers.

6. The computer program of claim 2, wherein said computer code for generating an expenditure index further comprises computer code for calculating an alcohol purchase percentage.

7. The computer program of claim 1, wherein the at least one purchase is an online purchase.

8. A method for screening at least one purchase with at least one account number in an electronic data processing system, comprising:
generating a regularity indicia for said at least one account number based on grocery purchases with said at least one account number;
purchasing at least one good online with said at least one account number from an online merchant; and
reporting said regularity index to said online merchant.

9. The method of claim 8, wherein said step of generating said regularity indicia further comprises:
generating a purchasing index based on the cost of each of a plurality of purchased items;
generating a category expenditure index based on purchases of at least one specific category of goods; and
producing said regularity indicia relative to said purchase index and said category expenditure index.

10. The method of claim 9, wherein said step of generating a category expenditure index further comprises generating an alcohol expenditure index based on purchases of alcoholic beverages.

11. The method of claim 9, wherein said step of generating a category expenditure index further comprises generating a grocery expenditure index based on purchases of consumable groceries.

12. The method of claim 9, wherein said step of generating said purchase index number further comprises:
categorizing said grocery item purchases into a plurality of price tiers;
calculating at least one purchase percentage relative to each of said plurality of price tiers; and
calculating a purchase index based one said at least one purchase percentage of each of said plurality of price tiers.

13. The method of claim 9, wherein said step of generating an expenditure index further comprises calculating an alcohol purchase percentage.

14. The computer program of claim 8, wherein the at least one purchase is an online purchase.
